(19) United States
(12) Patent Application Publication
(10) Pub. No.: US 2004/0074989 A1
(43) Pub. Date: Apr. 22, 2004

(54) Air stabilizing copper cap for a spray gun

(76) Inventor: Tiao-Hsiang Huang, Shin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/274,176

(22) Filed: Oct. 21, 2002

(51) Int. Cl. B05B 1/28

(52) U.S. Cl. 239/290

(57) ABSTRACT

An air stabilizing copper cap for a spray gun is essentially comprised of a plurality of axial holes provided on the periphery of the copper air cap, and a stopper ring being formed in the front end of the copper air cap so that a buffer chamber is created in the space between the front edge of the holes and the stopper; a hollow threaded tube is axially formed in the rear of the copper air cap, and both inner and outer threads are respectively provided in the space of the front end of the copper air cap and where external of the threaded tube to secure the nozzle head and the copper air cap onto the front end of the spray gun; so that high pressure air ejecting through the holes of the copper air cap is restricted in the buffer chamber before the stopper for pressure reduction to allow the release of stabilized air flow.

### BACKGROUND OF THE INVENTION

1. Field of the Invention

The present invention relates to an air stabilizing copper cap for a spray gun provided with air pressure stabilizing structure and more particularly to one that allows the air spray at a stabilized pressure.

2. Description of the Prior Art

Prior spray guns as disclosed in U.S. Pat. Nos. 4,572,437, 5,180,104, 5,775,598, 5,941,457, wherein, all their jetting structures are assembled by a plurality of members. The nozzle provides at least one circle of jets around the painting outlet. Some of the jets also provide a buffer chamber to adjust air pressure. The common shortcoming of the prior arts is that they have too many members and their structures are more complex. It is not convenient to assemble the product and the producing cost is high.

### SUMMARY OF THE INVENTION

The primary objective of the present invention is to provide an air stabilizing copper cap for a spray gun, essentially comprised of a plurality of holes provided in the air cap and a stopper ring being formed in the front end of the copper air cap so that a buffer chamber is created in the space between the front edge of the holes and the stopper; a hollow threaded tube is axially formed in the rear of the copper air cap, and both inner and outer threads are respectively provided in the space of the front end of the air cap and where external to the threaded tube to secure the nozzle head and the air cap onto the front end of the spray gun; so that high pressure air ejecting through the holes of the copper air cap head is restricted in the buffer chamber before the stopper for pressure reduction to allow the release of stabilized air flow.

### BRIEF DESCRIPTION OF THE DRAWINGS

FIG. 1 is a perspective view of the present invention.

FIG. 2 is a cross-sectional view of an assembly of the present invention.

FIG. 3 is a view showing the airflow direction of the present invention.

### DETAILED DESCRIPTION OF THE INVENTION

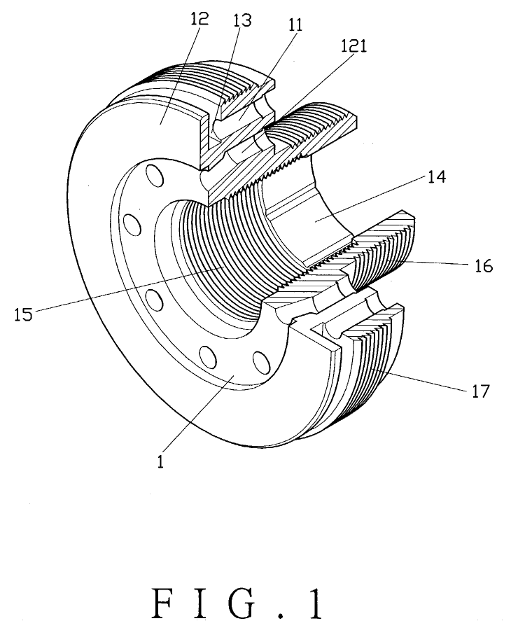

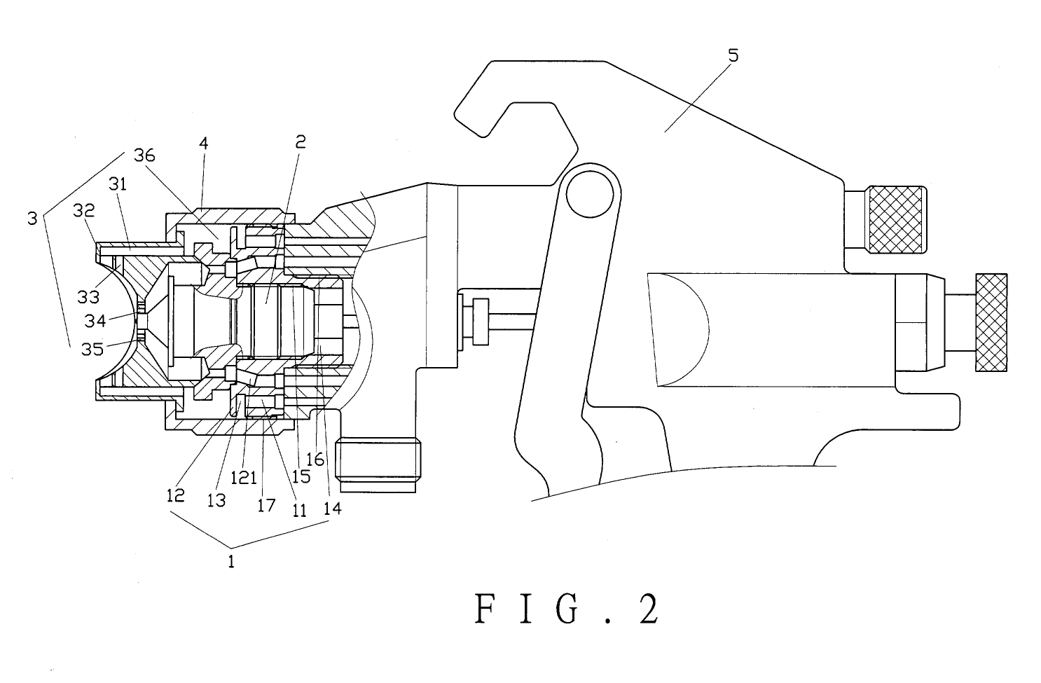

Referring to FIGS. 1 and 2, the present invention is essentially comprised of a copper air cap (1), a nozzle head (2), a nozzle (3), a nut (4) and a spray gun (5). The nozzle head (2), the nozzle (3), the nut (4) and the spray gun (5) are structures generally known to those who are familiar with the prior art.

The body of the copper air cap (1) is a hollow tube, with a plurality of holes (11) provided on the inner wall in the circumference of the tube, and a ring stopper (12) is separately formed in the front of the copper air cap (1) so to create a buffer chamber (13) between the stopper (12) and the wall provided with the holes (11). The stopper (12) comprises a plurality of slanting holes (121) on the inner wall. A hollow threaded tube (14) is axially formed in the rear of the air cap (1). Both internal and external threads (15) and (16) are respectively provided in the space where the tube (14) corresponds to the inner space of the front end of the air cap (1) and external to the rear end of the copper air cap (1). The external surface of the copper air cap (1) is also provided with external threads (17).

Now referring to FIG. 2, the threaded tube (14) of the copper air cap (1) is threaded to the center of the front end of the spray gun (5) and the nozzle head (2) is threaded with the internal threads (15) in the center of the copper air cap (1). The nozzle (3) in conjunction with the nut (4) is threaded with the external threads (17) of the copper air cap (1). An air chamber (36) is formed between the nozzle (3) and the stopper (12) of the copper air cap (1). Furthermore, an air outlet base (32) provided inside an air duct (31) is each provided in symmetry in the nozzle (3) while an air outlet (33) is each provided at the inner edge of the air outlet base (32). An ejection opening (34) and a plurality of air transport openings (35) are provided at the center of the nozzle (3).

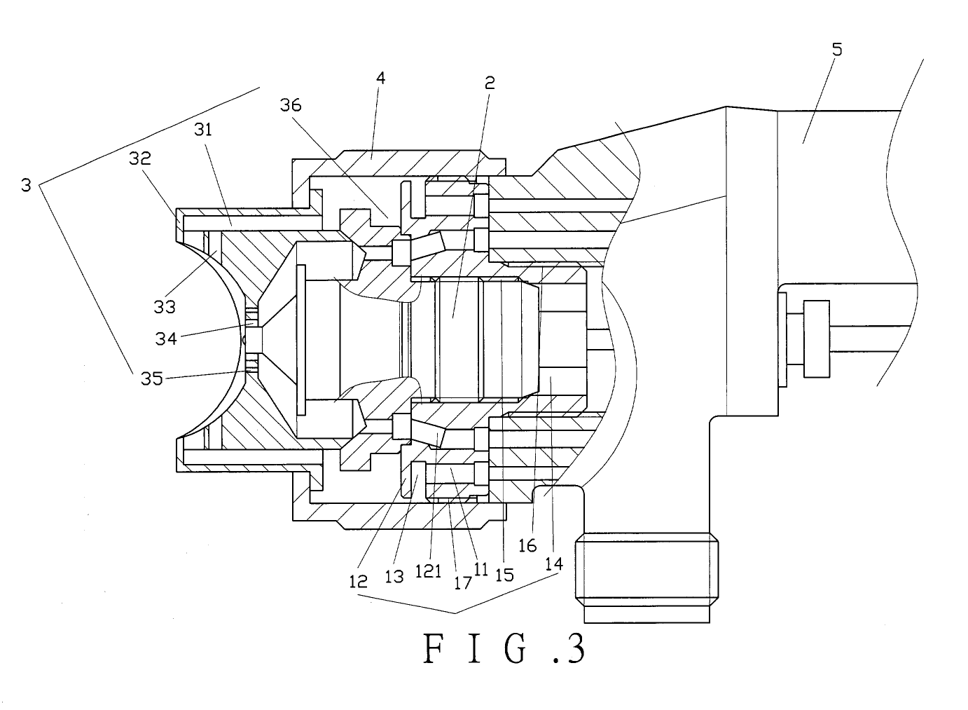

In practice, as illustrated in FIG. 3, pressurized air from the spray gun (5) is respectively ejected from the holes (121) of the stopper (12) and the holes (11) of the copper air cap (1). Wherein, the air delivered through the holes (121) flows through the nozzle head (2) and is released through the air transport openings (35) and the ejection opening (34) of the nozzle (3); meanwhile, the air delivered through the holes (11) of the copper air cap (1) is first restricted by the stopper (12) to be reduced with its pressure in the buffer chamber (13) before being bypassed into the air chamber (36) where an air circulation current with stabilized pressure is formed, then the air is released through the air ducts (31) in the air outlet bases (32) of the nozzle (3). Once the air is released at stabilized pressure, the problems of over-pressurized or unstable air pressure resulted in heterogeneous coating on the work piece, or air pollution can be eliminated.

I claim:

1. An air stabilizing copper cap for a spray gun comprising a plurality of holes provided on an inner wall of said copper air cap; a ring stopper being separately provided in a front end of said copper air cap to form a buffer chamber between said stopper and said holes; a hollow threaded tube being axially formed in a rear of said copper air cap, and both internal and external threads being provided respectively inside a front end of said copper air cap and on outer surface of a rear end of said hollow threaded tube; said copper air cap being secured at a front end of said spray gun, and pressurized air being ejected from said holes of said copper air cap and released at stabilized air pressure before being reduced with pressure in said buffer chamber as restricted by said stopper.
